(19) United States
(12) Patent Application Publication
(10) Pub. No.: US 2017/0309921 A1
(43) Pub. Date: Oct. 26, 2017

(54) FUEL CELL ELECTRODE

(71) Applicant: FORD GLOBAL TECHNOLOGIES, LLC, DEARBORN, MI (US)

(72) Inventors: Kerrie K. Gath, Pittsfield, MI (US); Chunchuan Xu, Troy, MI (US); Jun Yang, Bloomfield Hills, MI (US); Zijie Lu, Novi, MI (US)

(21) Appl. No.: 15/133,268

(22) Filed: Apr. 20, 2016

(51) Int. Cl. H01M 4/88; H01M 4/90; H01M 4/96

(52) U.S. Cl. CPC H01M 4/8871; H01M 4/96; H01M 4/8803; H01M 4/9016; H01M 4/9041

(57) ABSTRACT

A fuel cell electrode includes a carbon nanofiber substrate and a continuous film of up to 100 atom-thick monolayers forming a network of interconnected electrocatalyst nanoparticles deposited on the carbon nanofiber substrate such that at least some of the nanoparticles are directly adhered to uppermost nanofibers of the substrate to form a layer resistant to electrocatalyst depletion.

### TECHNICAL FIELD

The disclosure relates to a fuel cell assembly and a method of producing the same.

### BACKGROUND

Fuel cells, such as proton exchange membrane fuel cells (PEMFC), represent an attractive source of electricity due to zero-emissions generation and increased energy security. Among the primary components of each fuel cell are two electrodes and an ion conducting electrolyte. The design of the electrodes requires delicate optimization of materials and production processes to ensure good conductance of gas, electrons, and protons such that the resultant electrode is efficient, not prone to flooding, and does not overly deteriorate during use. To improve its catalytic function, it is desirable to include precious metal electrocatalyst onto the electrode. To deposit the electrocatalyst, various solution-based methods including chemical vapor deposition are known.

### SUMMARY

In at least one embodiment, a fuel cell electrode is disclosed. The fuel cell includes a carbon nanofiber substrate. The fuel cell may further include a continuous film of up to 100 atom-thick monolayers forming a network of interconnected electrocatalyst nanoparticles. The nanoparticles may be on the carbon nanofiber substrate such that at least some of the nanoparticles are directly adhered to uppermost nanofibers of the substrate to form a layer resistant to electrocatalyst depletion. The electrocatalyst nanoparticles may include platinum, platinum alloys, platinum oxides, or a combination thereof deposited via physical vapor deposition. The electrode may be a cathode and a density of the nanoparticles may be from about 0.02 mg/cm² to 1 mg/cm². The carbon nanofiber substrate may include a hollow hexagonal lattice having a regular arrangement of carbon atoms such that each carbon atom forms a vertex. The carbon nanofiber substrate may include a plurality of nanotubes about 0.7 nm to 100 nm in diameter. The plurality of nanotubes may form a network.

In another embodiment, a fuel cell is disclosed. The fuel cell includes a carbon nanofiber substrate. The fuel cell may further include a metal or metal oxide adhered to uppermost carbon fibers of the substrate. Further still, the fuel cell may include a film of up to 100 atom-thick monolayers forming a network of interconnected electrocatalyst nanoparticles. The nanoparticles may be deposited on the substrate such that at least some of the nanoparticles are directly adhered to the uppermost carbon fibers of the substrate, to the metal or metal oxide, or both to form a layer resistant to electrocatalyst depletion. The metal or metal oxide may be arranged on the uppermost carbon fibers to form intersections of the carbon nanofiber and the metal or metal oxide, and the nanoparticles are adhered to the intersections. The metal or metal oxide may form a layer arranged between the carbon nanofiber substrate and the network of the nanoparticles. The electrocatalyst nanoparticles may include platinum, platinum alloys, platinum oxides, or a combination thereof deposited via physical vapor deposition. The metal or metal oxide may include Co, Ni, Mn, Ru, Rh, Pd, Os, Ir, Au, Nb, Ta, Mb, W, or a combination thereof. The electrode may be an anode and wherein a density of the electrocatalyst nanoparticles may be from about 0.02 mg/cm² to 1 mg/cm². The density of the metal or metal oxide may be from about 0.05 mg/cm² to 3 mg/cm².

In yet another embodiment, a fuel cell electrode is disclosed. The electrode may include at least a first and second layer of carbon nanofiber substrate. Each layer may include a continuous film of up to 100 atom-thick monolayers forming a network of interconnected electrocatalyst nanoparticles deposited on the substrate such that at least some of the nanoparticles are directly adhered to uppermost carbon fibers of the substrate. Each carbon nanofiber substrate layer may be impregnated with an ionomer solution. An amount of ionomer in the first layer, arranged adjacent to a proton exchange membrane, may be higher than an amount of ionomer in the second layer spaced apart from the membrane. At least one of the layers may further include a metal or metal oxide adhered to the uppermost carbon fibers of the substrate and to at least some of the electrocatalyst nanoparticles. The fuel cell electrode may further include a metal or metal oxide adhered to the uppermost carbon fibers of the substrate and to at least some of the electrocatalyst nanoparticles of the first layer. Each layer may have the same dimensions. The fuel cell electrode may further include at least a third layer having a different composition than the first and second layers. A density of the electrocatalyst nanoparticles may gradually decrease throughout the layers in a direction away from a gas diffusion layer.

### BRIEF DESCRIPTION OF THE DRAWINGS

FIG. 1 depicts an exploded schematic view of an example fuel cell stack according to one or more embodiments;

FIG. 2 depicts a schematic view of a prior art electrode substrate with individual grown carbon fibers and electrocatalyst particles onto the fibers deposited by chemical vapor deposition;

FIG. 3 shows a schematic view of an exemplary carbon nanofiber substrate with a network of electrocatalyst nanoparticles deposited onto the substrate by physical vapor deposition according to one or more embodiments;

FIG. 4A depicts a perspective view of a single-walled carbon nanotube with a monolayer of electrocatalyst nanoparticles forming a network deposited by physical vapor deposition;

FIG. 4B depicts a scanning electron microscope photograph of a network of single-walled carbon nanotubes;

FIG. 5A shows a perspective view of a single-walled carbon nanotube having a network of electrocatalyst nanoparticles attached to metal or metal oxide deposited onto the carbon atoms forming discreet layers;

FIG. 5B shows a perspective view of a single-walled carbon nanotube having a layer of electrocatalyst nanoparticles and metal or metal oxide;

FIG. 6 shows a perspective view of a single-walled carbon nanotube with three monolayers of electrocatalyst nanoparticles deposited by physical vapor deposition; and

FIGS. 7A-7C depict various schematic exemplary embodiments of a carbon nanofiber substrate having different amount, composition, and dimensions of layers.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Fuel cells are devices converting chemical potential energy from a fuel, usually hydrogen, into electrical energy through a chemical reaction of positively charged hydrogen ions with oxygen or another oxidizing agent. Fuel cells are capable of producing electricity as long as they have a continuous source of the fuel and oxygen. Many different types of fuel cells have been developed and are being utilized to power a plethora of different vehicles. Exemplary types of fuel cells include PEMFCs, phosphoric acid fuel cells (PAFCs), alkaline fuel cells (AFCs), solid oxide fuel cells (SOFCs), direct methanol fuel cells (DMFCs), molten carbonate fuel cells (MCFCs), etc.

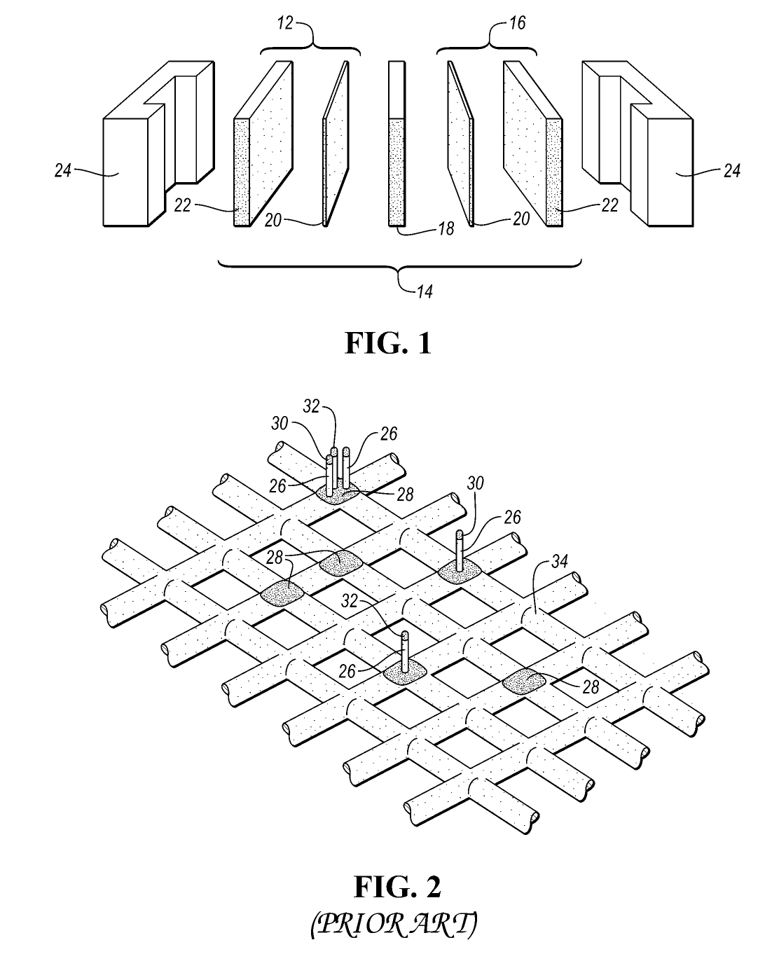

Every fuel cell includes one or more stacks 10 of several components which are adjacent to each other. An exemplary stack of a fuel cell 10 is depicted in FIG. 1 and includes an anode 12, a membrane electrode assembly (MEA) 14, and a cathode 16. An electrolyte is present, carrying electrically charged particles between the two electrodes 12, 16. Typically, MEA 14 includes a polymer electrolyte membrane (PEM) 18, two catalyst layers 20, and two gas diffusion layers (GDL) 22. The stack 10 further includes an end or bipolar plate 24 on each side.

As a pressurized fuel enters the fuel cell on the anode side 12, the fuel undergoes oxidation reactions resulting in positively charged hydrogen ions and electrons. The positively charged hydrogen ions travel through the electrolyte while the electrons are forced to travel from the anode 12 to the cathode 16 via an external circuit, producing direct current electricity. If alternating current is needed, the direct current output may be routed through an inverter. Oxygen enters the cathode 16, combines with electrons returning from the electrical circuit and the hydrogen ions. Alternatively, depending on the type of electrolyte used, the oxygen combined with the electrons may travel through the electrolyte and combine with hydrogen ions at the anode 12. Regardless of the location where oxygen and hydrogen ions combine, together they form water, which is removed from the fuel cell.

The anode 12 and the cathode 16 each include a catalyst layer 20 facilitating the reactions of oxygen and hydrogen. At the anode 12, a catalyst oxidizes the fuel into the hydrogen protons and electrons. The cathode catalyst catalyzes oxygen reduction reaction which results in formation of water. The chemical reactions at the cathode 16 have a more complicated reaction mechanism than the reactions at the anode 12. As a result, the reactions at the cathode 16 are slow and require a substantial amount of catalyst to increase the speed of the reaction. A desirable catalyst must be sufficiently chemically active to be able to activate O₂, yet stable enough to withstand the corrosive environment at the cathode 16. Further still, the catalyst must be capable of facilitating release of product water from the catalyst surface to free up catalytic sites once the reaction is complete. Additionally, the catalyst must be selective enough to produce the desired product while minimizing production of undesirable intermediates. Thus, typically, the cathode 16 requires a higher catalyst loading than the anode 12.

If a noble metal such as platinum is used as a catalyst, the effective amount required may be ten times higher at the cathode 16 than at the anode 12. While other materials may be used as a catalyst, platinum offers several advantages. For example, platinum is one of the few elements capable of withstanding the acidic environment of the fuel cell. On the cathode 16, platinum has the highest activity of all bulk metals. During the preferred ORR mechanisms, platinum binds first to O₂ and then the OH. On the platinum surface, the O═O bond is usually broken on adsorption so that the reaction mechanism can proceed according to the desired dissociate mechanism with minimal production of H₂O₂ which typically results when O₂ is adsorbed on a metal surface without the O═O bond being broken. Platinum thus helps prevent presence of free H₂O₂ which may be highly damaging in the fuel cell environment.

Additionally, at the anode 12, platinum oxidizes hydrogen gas faster at any given potential than other catalyst materials. Hydrogen gas adsorbs to platinum molecules, the H—H bond breaks, and two H—Pt bonds form. Removal of electrons from each hydrogen atom follows at the anode. The bond between H—Pt has an optimal strength. Metals having weaker interactions with hydrogen gas are less efficient as the adsorption of hydrogen gas to the metal. On the other hand, metals which may bind hydrogen to the metal too strongly may not efficiently release the electrons and the positively charged hydrogen ions. Because of the nature of the catalysts, the type of catalyst used may significantly affect the cost of the fuel cells. Thus, it would be desirable to provide a method which would deliver an optimized amount of the noble metal onto the electrode substrate material, and stabilize it such that the advantage of the noble metals can be utilized, while minimizing costs associated with their use.

Typically, a solution-based or wet-chemical method is used to deliver a fuel cell electrocatalyst powder onto a substrate. The powder is then processed into an ink which is coated onto a GDL 22 which is used to help remove water on the cathode side 16 while delivering the hydrogen to the anode side 12 and oxygen to the cathode side 16. The solution-based method, however, may result in uneven distribution of the metal particles onto the substrate. Additionally, the electrocatalyst delivered by the wet-chemical method typically forms agglomerations. The agglomerations are responsible for the high electrocatalyst loading as at least some of the individual atoms within the agglomerations are not being utilized. Additionally still, wet-chemical methods utilize chemistry such as chloroplatonic acid which may be incompatible with efforts to provide environmentally conscious fuel cell solutions.

An exemplary wet-chemical method of an electrocatalyst on a substrate typically includes deposition of a metal catalyst such as iron, cobalt, nickel, or their combination, on a substrate like a gas diffusion layer, growing individual carbon structures in situ, and then depositing the electrocatalyst on the grown carbon structures. To initiate the growth of the carbon structures, a process gas such as ammonia and a carbon-containing gas such as acetylene are supplied to the reactor. The process includes a number of steps and results in individual carbon structures, such as individual carbon fibers, 26 grown on a metal catalyst 28, as depicted in FIG. 2. The carbon fibers 26 are typically randomly oriented, unless a strong electric field is generated during the growth. The carbon fibers 26 are spaced apart from each other. When closely spaced, the grown fibers 26 may have vertical growth direction and may be arranged in a relatively dense array of structures.

Some of the grown carbon fibers 26 may be supporting agglomerations 30 of the electrocatalyst material 32. The amount and/or size of the agglomerations 30 may increase in time as the electrocatalytic particles 32 have an increased tendency to aggregate into larger particles over time when the fuel cell is being used or when carbon monoxide attaches to their surface. The agglomerations 30 thus contribute to the loss of the electrocatalyst efficiency. The individual carbon structures 26 have a tendency to detach from the substrate 34 and carry the electrocatalyst material 32 with them, which further lowers efficiency of the fuel cell system as the system's structural stability is compromised and the electrocatalyst-loaded-substrate disintegrates. The areal loading of the electrocatalytic particles 32, constrained by the number of the in-situ grown carbon nanofibers 26, may not be sufficient to support high power output of the fuel cell stack. Furthermore, the vertically oriented carbon nanofibers 26 may protrude into the polymer electrolyte membrane 18, breaking the integrity of the membrane 18, and increasing the risks of gas crossover and pin holes in MEA 14.

The embodiments of the current disclosure overcome one or more above-named disadvantages. In at least one embodiment, depicted in FIG. 3, a fuel cell electrode 36 is disclosed. The electrode 36 may be an anode 12 or a cathode 16. The electrode 36 includes a substrate 38 and a network 40 of electrocatalyst nanoparticles 42. The substrate 38 may be any base material capable of providing support for the electrocatalyst 42 and suitable for a fuel cell. The substrate 38 may be a carbon fiber support. The substrate 38 may be a composite support such as graphite, carbon nanofibers, macromolecules, the like or a combination thereof. The substrate 38 may include members of the fullerene structural family such as carbon nanotubes, nanospheres, nanoellipsoids, the like, or a combination thereof. The substrate 38 may include a honeycomb lattice structure or a three-dimensional graphene material having periodic and nonperiodic honeycomb-like portions. The substrate 38 may include a network 46 of carbon fibers. The substrate 38 may be a carbon fiber paper, a carbon fiber cloth, a carbon nanotube sheet, a carbon nanotube yarn, a carbon nanotube tape, or the like, having a pore size of about 50 nm to 10 μm, 5 nm to 500 nm, or 1 nm to 200 nm. The substrate material 38 may have a diameter of 50 nm to 1 μm, 10 nm to 500 nm, or 0.7 nm to 200 nm. The surface area of the substrate 38 may be from about 200 m²/g to 5,000 m²/g.

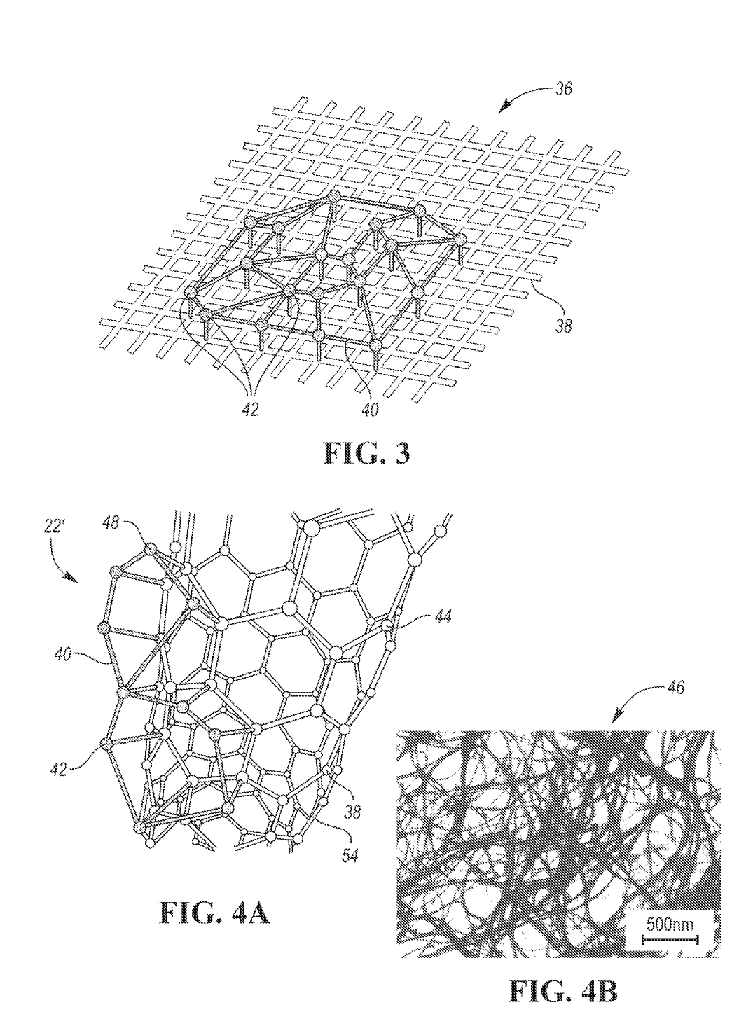

The substrate 38 may be formed by carbon nanotubes 44, examples of which are depicted in FIGS. 4A and 4B. Each nanotube 44 features a hollow structure with the walls formed by graphene, an allotrope of carbon in the form of a two-dimensional, atomic-scale, honeycomb lattice in which one atom forms each vertex. The carbon nanotubes 44 represent seamless cylindrical hollow fibers. The nanotubes 44 include a hexagonal lattice of covalently bonded carbon atoms having a regular arrangement of carbon atoms within the lattice. The carbon nanotubes 44 thus form straw-like cylinders of pure carbon. The nanotubes 44 may be single-walled, as is depicted in FIGS. 4A and 4B, or multi-walled. Additionally, the nanotubes 44 may be arranged into a variety of structures. Exemplary structures may include a nanobud combining nanotubes with fullerenes, a carbon torus referring to a carbon nanotube bent into a doughnut shape, graphitized carbon nanotubes combining graphitic foliates grown along the sidewalls of multi-walled nanotubes, a carbon peapod referring to a carbon nanotube with a trapped fullerene inside, cup-stacked carbon nanotubes having a stacked microstructure of graphene layers, the like, or a combination thereof. The multi-walled nanotubes are made of coaxial cylinders having interlayer spacing close to that of the interlayer distance in graphite which is about 0.34 nm (3.4 Å). An exemplary structure of the multi-walled nanotube may include a Russian nesting doll model referring to a set of concentric nanotubes of decreasing diameter placed one inside another or a parchment model referring to a nanotube sheet arranged as a partially unrolled scroll. The nanotubes 44 may be capped with half of a fullerene molecule.

The nanotubes 44 may have a diameter of about 5 nm to 100 nm, 1 nm to 50 nm, 0.7 nm to 30 nm. The band gap may be about 0-2 eV. The nanotubes 44 may have sufficient dimensions to form a network 46, an example of which is shown in FIG. 4B. The nanotubes 44 may intertwine to form the network 46. As FIG. 4B illustrates, the nanotubes 44 within the network 46 may have a random configuration. Alternatively, the network 46 may have regularly spaced apart nanotubes 44, such that the network 46 displays a regular arrangement. The nanotubes 44 within the network 46 may have the same or different dimensions, orientation, alignment, helicity, properties, or the like. The nanotubes 44 which are adjacent to each other may adhere together via dispersion forces between electrons.

The carbon nanotube network 46 exhibits better material properties such as higher electrical conductivity, thermal properties, and mechanical properties than amorphous carbon, loose nanotube powders, fibers grown by wet chemical methods, or another graphitized carbon powder. Moreover, since the nanotubes 44 are hollow carbon tubes, they are very lightweight and thin, and the entire network 46 is strong but lightweight. Additionally, a substrate 38 comprised of the carbon nanotubes 44 and/or carbon nanotube network 46 is porous enough to allow gas and water vapor to pass through to the catalyst layer 20, thus potentially eliminating the need to include a separate GDL 22 in the fuel cell stack assembly 10. An additional advantage lies in the fact that a network of carbon nanotubes 46, unlike powder, loose fibers, or individual grown fibers which may detach, may have a size range suitable to prevent health risks associated with other nanomaterials such as inhalation or absorption by the skin. Thus, the process of producing the fuel cell electrode including a substrate 38 having the carbon nanotube network 46 may provide for a safer work environment.

The electrocatalyst nanoparticles 42 deposited on the substrate 38 are metallic particles. The nanoparticles 42 serve as an electrocatalyst in the fuel cell electrode 36. The nanoparticles 42 may serve as an oxygen reduction reaction catalyst (ORR). The nanoparticles 42 may be platinum, platinum alloys, platinum oxides, or a combination thereof. The nanoparticles 42 may include about 5% to 100% platinum, 15% to 70% platinum, or 20% to 50% platinum. The platinum alloys may be a combination of platinum and any element formed into nanoparticles with controllable size as long as the nanoparticles 42 retain their catalytic activity. The alloying element may be less expensive than platinum. Desirable alloying materials provide access of the platinum atoms to the surface of the alloyed particles such that platinum is available to promote the key reactions in the fuel cell. Exemplary elements may include yttrium, carbon, cobalt, manganese, rhodium, ruthenium, gold, niobium, titanium, tantalum, molybdenum, tungsten, iridium, the like, or their combination.

The nanoparticles 42 may form a network 40. The network 40 may be a continuous network. Alternatively, the network 40 may include one or more gaps or be partially discontinuous. The network 40 may be two-dimensional such that the nanoparticles 42 may form 1 or more monolayers. The amount of monolayers 48 may be about 1 to 100 or more. A single monolayer 48 or a plurality of monolayers 48 of nanoparticles 42 may be deposited onto the carbon substrate 38. A monolayer 48 is a one-atom thick layer of interconnected electrocatalyst particles 42. The network of nanoparticles 40 provides their structural stability as bond bridges are formed between the individual nanoparticles 42. The individual nanoparticles 42 are thus anchored at the deposition site. The bonds between nanoparticles 42 within the network 40 may be physical, mechanical, chemical, or a combination thereof. Regardless of the type of the bond, the interconnections between individual nanoparticles 42 ensure that the nanoparticles 42 are being held in place and that the electrocatalyst 42 is not being detached. The entire network 40 is more stable and does not dissolve as fast as a substrate 34 with distinct electrocatalyst nanoparticles 42. The network 40 may form a thin film on the substrate 38. The thickness of the film may be from 3 to 100 layers.

The size of the electrocatalyst nanoparticles 42 may be from about 1 nm to 15 nm, 2 nm to 9 nm, or 5 nm to 7 nm in diameter. The size of the nanoparticles 42 has to be sufficient to provide active surface area large enough to sustain electrochemical activity. The nanoparticles 42 may be capable of producing from up to 3.0 A of electric current/g of platinum. The density of the nanoparticles 42 deposited onto the substrate 38 may be from about 0.1 mg/cm² to 1 mg/cm², 0.05 mg/cm² to 0.6 mg/cm², or 0.02 mg/cm² to 0.3 mg/cm². The density or loading may be the same or different on an anode 12 and a cathode 16. The density of the nanoparticles 42 may be the same or different throughout respective monolayers 48 of nanoparticles 42. The density may be tailored. For example, the monolayers 48 arranged closest to a fuel cell membrane 18 may have the lowest density. The opposite arrangement is also possible such that the monolayers 48 closest to the membrane 18 have lower density of the nanoparticles 42 and higher content of ionomer (not depicted) to increase proton conductivity. A higher content of the nanoparticles 42 in a monolayer 48 adjacent to a GDL 22 may increase electrical conductivity. Alternatively, each monolayer 48 may have the same density, or only several monolayers 48 may have the same density of the nanoparticles 42. The density of the nanoparticles 42 in the electrode 36 may gradually decrease in a direction away from or towards a GDL 22. The nanoparticles 42 may be diffusively spread such that their spatial distribution within a monolayer 48 is regular. In comparison to a CVD-deposited electrocatalyst material 32, nanoparticles 42 of the current disclosure are dispersed in a more uniform manner. The ionomer content may be diffusively spread such that the spatial distribution of the ionomer within the carbon substrate is regular, or may gradually decrease in a direction away from the polymer electrolyte membrane 18, in a multilayer electrode structure, ensuring high proton conductivity in the electrode 36.

The nanoparticles 42 are deposited onto the substrate 38 in such a way that at least some of the nanoparticles 42 are directly adhered to the uppermost carbon fibers of the substrate 38 to form a layer resistant to electrocatalyst depletion. Such arrangement of nanoparticles 42 on the substrate 38 may be achieved using a physical vapor deposition (PVD). PVD is a general term describing a number of vacuum deposition methods used to produce thin films. PVD involves condensation and evaporation of material and an atom-by-atom transfer of the material from the solid phase to the vapor phase and back to the solid phase. PVD produces a vapor of the solid material by heating or sputtering. The vaporized material is then transferred from the source to a substrate by line-of-sight, molecular flow, or vapor ionization by creating plasma. The vaporous phase is then deposited onto the substrate. The process may be repeated to form a number of layers of the deposited material. PVD is carried out at temperatures of about 0° C. to 1000° C. Exemplary PVD methods include cathodic arc deposition, electron beam PVD, sputter deposition including pulse DC sputtering, DC sputtering, radiofrequency sputtering, and ion-specific sputtering, evaporative deposition, and pulsed laser deposition.

An exemplary PVD method utilized to prepare the fuel cell electrode 36 described above may include placing the carbon fiber substrate 38 into a vacuum chamber. The substrate 38 is then subjected to sputtering under standard vacuum conditions in an inert atmosphere of Ar, Kr, Xe, the like, or their combination, depending on what type of metal is being sputtered. Hydrogen or oxygen may be provided to reduce (H₂) or oxidize (O₂) the environment. The nanoparticles 42 are then evaporated and transported in their vapor phase to the substrate 38, onto which they are deposited. The nanoparticles 42 may form a thin film. The coated substrate 38′ may be heat cured. Optionally, the catalyst loaded substrate 38′ may be impregnated with an ionomer solution such as sulfonated tetrafluoroethylene-based fluoropolymer-copolymer at the same time or prior to stacking of the coated substrate 38′ as layers to assemble a fuel cell stack 10. The ionomer solution may be applied by dipping, spraying, printing, brushing, spin coating, or in any other suitable manner, onto the catalyst coated substrate 38′. A PEM 18 may be provided adjacent to the coated substrate 38′. The PEM 18 may be a perfluorsulfonic membrane. The PEM 18 may be about 2 μm to 100 μm thick. The end or bipolar plates 24 may be added. In this manner, a portion of a fuel cell 10 including a plate 24, an anode 12, a membrane 18, a cathode 16, and a plate 24 adjacent to each other may be assembled. A fuel cell may contain about 3 to 400 such portions or stacks 10.

The advantage of the PVD process to deposit nanoparticles 42 onto the substrate 38 lies in the ability to tailor the density of the nanoparticles 42 in various monolayers 48 to be deposited onto the substrate 38. Other advantages include providing higher temperature and impact strength of the nanoparticle coating than if deposited by other methods such as wet chemical methods. The abrasion resistance of the nanoparticles 42 is also higher when compared to wet chemical methods. A processing advantage lies in the fact that the method presents a more simple process free of supplementary chemicals which pose environmental issues. As a result, the process is faster, cheaper, and more environmentally friendly.

Additionally, the combination of a carbon fiber substrate 38 such as the carbon nanotubes 44 and the electrocatalyst nanoparticles 42 deposited onto such substrate 38 ensures that the lifetime of the fuel cell is increased. The nanoparticles 42 may be bound to the substrate 38 by chemical, physical, mechanical bonds, or a combination thereof. The bonds between the nanoparticles 42 and the upper-most fibers of the carbon substrate 38 provide optimal strength to hold the nanoparticles 42 at the site of their deposition. At the same time, individual carbon molecules of the substrate 38 are held in place by a network 46 such that the individual carbon atoms are prevented from detaching and carrying away the nanoparticles 42. The combination of the two networks—the carbon fiber network 46 and the nanoparticle network 40 thus establish an optimal structural stability of the fuel cell electrode 36.

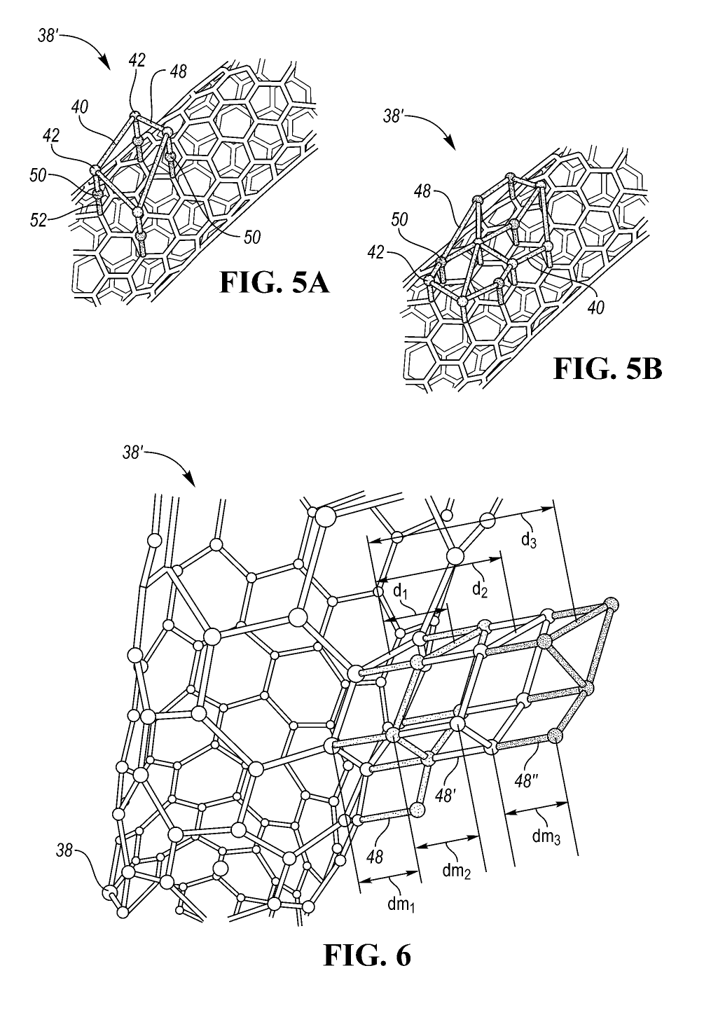

To provide additional acidification, metal or metal oxides 50 may be included. Specifically, a combination of the nanoparticles 42 and a metal or metal oxide may further prevent the coated substrate's 38′ structure from disintegrating by improving geometry of the structure and ensuring that the electrocatalyst nanoparticles 42 do not form aggregations or that a formation of the aggregations is minimized prior to utilization of the fuel cell. A metal or metal oxide 50 may further improve catalytic activity of the electrode 36. In at least the embodiments depicted in FIGS. 5A and 5B, a metal or metal oxide 50 is included within the framework of the electrode 36. As FIGS. 5A and 5B illustrate, the metal or metal oxide 50 may be distributed along the upper-most carbon fibers to enhance the formation of the electrocatalyst nanoparticle network 40. In FIG. 5A, the metal or metal oxide 50 may form a layer between the carbon substrate 38 and the nanoparticles 42. In FIG. 5B, the metal or metal oxide 50 is arranged in the same plane as the nanoparticles 42. The nanoparticles 42 may be thus attached to the metal or metal oxide 50, the atoms of the substrate 38, or both. The nanoparticles 42 tend to be deposited on the intersections 52 of the carbon atoms and the metal or metal oxide 50, as can be seen in FIG. 5A. In such embodiments, the nanoparticles 42 may be attached to both the carbon atoms and the metal or metal oxide 50. Alternatively, the metal or metal oxide 50 may function as a barrier between the carbon fibers and the nanoparticles 42. Alternatively still, the metal or metal oxide 50 may be deposited between at least some of the monolayers 48 of the electrocatalyst particles 42. The metal or metal oxide 50 may be deposited onto the substrate 38 prior to deposition of the nanoparticles 42 or be co-deposited with the nanoparticles 42.

The metal or metal oxide 50 may include cobalt, manganese, nickel, rhodium, ruthenium, gold, niobium, titanium, tantalum, molybdenum, tungsten, iridium, the like, their combination, or any other metal compatible with fuel cell use. The amount of the metal or metal oxide 50 to be included may be from about 0.05 mg/cm² to 3 mg/cm², 0.5 mg/cm² to 2 mg/cm², or 0.2 mg/cm² to 1 mg/cm² of the substrate.

The electrode 36 may be assembled from one or more layers 54 of the coated substrate 38′. Exemplary number of layers 54 may be 1 to 20 or more, 2 to 10, or 3 to 6. A layer 54 may include a substrate 38, metal of metal oxide 50, a network of nanoparticles 42, or a combination thereof Alternatively, a layer 54 may include the substrate 38 and a network of nanoparticles 42, but be free of the metal or metal oxide 50.

Referring back to FIG. 4A, the material forming an electrode 36 may include a single layer 54 of a substrate 38 and a single network of nanoparticles 40 deposited onto the substrate 38, forming a first monolayer 48. FIG. 6, on the other hand, illustrates an embodiment in which multiple monolayers of nanoparticles 48, 48′, 48″ are deposited onto the substrate 38 such that the first monolayer 48 is attached to the substrate 38, the second monolayer 48′ is attached to the first monolayer 48, and the third monolayer 48″ is attached to the second monolayer 48′. Additional nanoparticle monolayers 48 may be present. The monolayers 48 may be spaced apart from the substrate 38 by a distance d. For example, as FIG. 6 further illustrates, the first monolayer 48 may be spaced apart from the substrate 38 with a distance d₁, the second monolayer 48″ may be spaced apart from the substrate 38 with a distance d₂ and the third monolayer 48′″ may be spaced apart from the substrate 38 with a distance d₃, wherein d₃ is greater than d₂ which is greater than d₁. The distance dₘ between individual monolayers 48 may be the same or different. For example, dₘ may gradually increase or decrease in the direction away from the substrate 38. Alternatively, the distance dₘ may vary throughout the monolayers in a random fashion. Alternatively still, the distance dₘ between every three (or a different amount of) layers may be the same but differ from a distance dₘ between at least one other layer.

In one or more embodiments, the material forming an electrode 36 may include multiple layers 54 of the coated substrate 38′. Each layer 54 may have one or more monolayers 48 of nanoparticles 42 forming one or more sublayers of the layer 54. Additionally, one or more sublayers of the metal or metal oxide 50 may be present. Alternatively still, the metal or metal oxide 50 may be incorporated within the one or more monolayers 48 of nanoparticles 42. The thickness of each layer 54 may be the same or different. Additionally, the electrocatalyst particles 42 may be spaced apart from each other so that a continuous network is not formed, and the nanoparticles 42 are individually connected to the substrate 38 and/or the metal or metal oxide 50. Alternatively still, the network 40 may form but may include gaps.

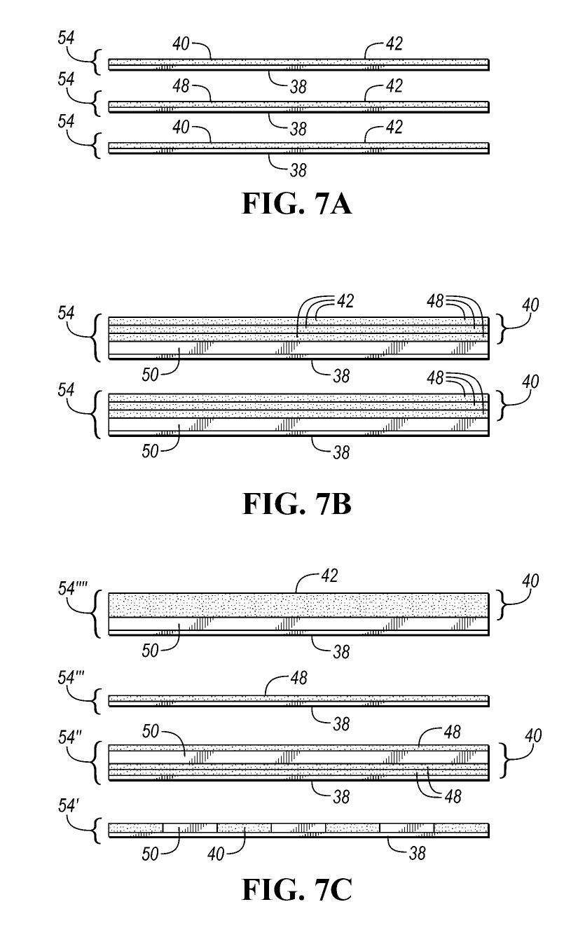

Different exemplary embodiments of a multi-layered electrode 36 are depicted in FIGS. 7A-7C. FIG. 7A illustrates three layers of the coated substrate 38′. Each layer 54 includes a substrate 38 and the electrocatalyst particles 42 forming networks 40. The electrocatalyst particles 42 form a single monolayer 48. FIG. 7B depicts two layers 54, each having a single layer of the substrate 38 supporting a layer of metal or metal oxide 50 and three monolayers 48 of the electrocatalyst particles 42 forming a network 40. All layers 54 in FIGS. 6A and 6B are uniform. In contrast, the material forming the electrode 36 may include layers 54 which differ from each other with respect to dimensions, composition, number of sublayers, orientation, other properties, or their combination. For example, in the embodiment depicted in FIG. 7C, the first layer 54′ includes a substrate 38 and a network of the electrocatalyst particles 42 intertwined with the metal or metal oxide 50. The second layer 54″ includes a substrate 38 and three monolayers 48 of the electrocatalyst particles forming a network 40. The metal or metal oxide 50 is present between the monolayers 48. The third layer 54′″ includes a substrate 38 and a single monolayer 48 of the electrocatalyst particles 42. The third layer 54′″ is substantially free of metal or metal oxide 50. The fourth layer 54″″ includes a substrate sublayer 38, a sublayer of metal or metal oxide 50, and a network 40 of electrocatalyst particles 42.

Further regarding the multi-layer structures, such as those depicted in FIGS. 7A-7C, ionomer impregnation is desirable to enable protons to be transported between individual layers 54. The layer 54 closest to the PEM 18 should contain the highest amount of ionomer while the outer layers 54 may contain lesser amount of ionomer. The amount of ionomer in the layer 54 closest to the PEM 18 may be from about 0.2 to 5.0 mg/cm². The amount of ionomer in the outer layers 54 may be from about 0.1 to 2.0 mg/cm². Any suitable ionomer is contemplated. Exemplary ionomers may include perfluorsulfonic acid or sulfonated hydrocarbon polymers.

The present disclosure further provides a method of forming a fuel cell electrode 36. In addition to the PVD process described above, the method includes producing the electrode 36 in a single step via PVD. The method includes providing a ready-made carbon fiber substrate 38, examples of which are named above. The carbon fiber substrate 38 includes a network of carbon fibers. The method is thus free of using and depositing metal catalysts and using a process gas and carbon-containing gas to grow the carbon substrate. The substrate 38 such as a network of carbon nanotubes 46 is supplied and individual monolayers 48 of the electrocatalyst nanoparticles 42 are deposited onto the substrate 38 such that a network 40 is created and a coated substrate 38′ is formed. The method contemplates depositing just one monolayer 48 of the nanoparticles 42. Alternatively, up to about 100 monolayers 48 may be deposited. Depositing the nanoparticles 42 may include tailoring individual monolayers 48 such that the density of nanoparticles 42 within at least one monolayer 48 differs from density of nanoparticles 42 in another monolayer, as was described above. Alternatively, the density of nanoparticles 42 within at least one portion of a single monolayer 48 may differ from at least one other portion. Depositing the nanoparticles 42 onto the substrate 38 may be provided on a roll-to-roll form. The method is free of utilizing chemicals such as chloroplatonic acid.

The method may further include depositing metal or metal oxide 50 onto the substrate 38. Alternatively, the formed electrode 36 may be metal or metal oxide 50 free. Depositing the metal or metal oxide 50 may include co-depositing the metal or metal oxide 50 with the nanoparticles 42. Alternatively, the metal or metal oxide 50 may be deposited prior to or after deposition of the nanoparticles 42.

The method may also include forming individual layers 54 of the electrode 36, stacking the layers 54, and arranging the layers 54 into a fuel cell stack including an end or bipolar plate 24, an anode 12, a membrane 18, a cathode 16, and an end or bipolar plate 24. The method includes a step of assembling a number of stacks 10 to provide a fuel cell assembly.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A fuel cell electrode comprising:
a carbon nanofiber substrate; and
a continuous film of up to 100 atom-thick monolayers forming a network of interconnected electrocatalyst nanoparticles deposited on the carbon nanofiber substrate such that at least some of the nanoparticles are directly adhered to uppermost nanofibers of the substrate to form a layer resistant to electrocatalyst depletion.

2. The electrode of claim 1, wherein the electrocatalyst nanoparticles comprise platinum, platinum alloys, platinum oxides, or a combination thereof deposited via physical vapor deposition.

3. The electrode of claim 1, wherein the electrode is a cathode and wherein a density of the nanoparticles is from about 0.02 mg/cm² to 1 mg/cm².

4. The electrode of claim 1, wherein the carbon nanofiber substrate includes a hollow hexagonal lattice having a regular arrangement of carbon atoms such that each carbon atom forms a vertex.

5. The electrode of claim 1, wherein the carbon nanofiber substrate includes a plurality of nanotubes about 0.7 nm to 100 nm in diameter.

6. The electrode of claim 5, wherein the plurality of nanotubes forms a network.

7. A fuel cell electrode comprising:
a carbon nanofiber substrate;
a metal or metal oxide adhered to uppermost carbon fibers of the substrate; and
an uninterrupted film of up to 100 atom-thick monolayers forming a network of interconnected electrocatalyst nanoparticles deposited on the substrate such that at least some of the nanoparticles are directly adhered to the uppermost carbon fibers of the substrate, to the metal or metal oxide, or both to form a layer resistant to electrocatalyst depletion.

8. The fuel cell electrode of claim 7, wherein the metal or metal oxide is arranged on the uppermost carbon fibers to form intersections of the carbon nanofiber and the metal or metal oxide, and the nanoparticles are adhered to the intersections.

9. The fuel cell electrode of claim 7, wherein the metal or metal oxide forms a layer arranged between the carbon nanofiber substrate and the network of the nanoparticles.

10. The electrode of claim 7, wherein the electrocatalyst nanoparticles comprise platinum, platinum alloys, platinum oxides, or a combination thereof deposited via physical vapor deposition.

11. The fuel cell electrode of claim 7, wherein the metal or metal oxide comprises Co, Ni, Mn, Ru, Rh, Pd, Os, Ir, Au, Nb, Ta, Mb, W, or a combination thereof.

12. The fuel cell electrode of claim 7, wherein the electrode is an anode and wherein a density of the nanoparticles is from about 0.02 mg/cm² to 1 mg/cm².

13. The fuel cell electrode of claim 7, wherein a density of the metal or metal oxide is from about 0.05 mg/cm² to 3 mg/cm².

14. A fuel cell electrode comprising:
at least a first and second layer of carbon nanofiber substrate, each layer including a continuous film of up to 100 atom-thick monolayers forming a network of interconnected electrocatalyst nanoparticles deposited on the substrate such that at least some of the nanoparticles are directly adhered to uppermost carbon fibers of the substrate,
wherein each carbon nanofiber substrate layer is impregnated with an ionomer solution.

15. The fuel cell electrode of claim 14, wherein an amount of ionomer in the first layer, arranged adjacent to a proton exchange membrane, is higher than an amount of ionomer in the second layer spaced apart from the membrane.

16. The fuel cell electrode of claim 14, wherein at least one of the layers further comprises a metal or metal oxide adhered to the uppermost carbon fibers of the substrate and to at least some of the electrocatalyst nanoparticles.

17. The fuel cell electrode of claim 14, further comprising a metal or metal oxide adhered to the uppermost carbon fibers of the substrate and to at least some of the electrocatalyst nanoparticles of the first layer.

18. The fuel cell electrode of claim 14, wherein each layer has the same dimensions.

19. The fuel cell electrode of claim 14, further comprising at least a third layer having a different composition than the first and second layers.

20. The fuel cell electrode of claim 14, wherein a density of the electrocatalyst nanoparticles gradually decreases throughout the layers in a direction away from a gas diffusion layer.
